(19) United States
(12) Patent Application Publication
(10) Pub. No.: US 2014/0043376 A1
(43) Pub. Date: Feb. 13, 2014

(54) METHOD FOR INSERTING FRAMES IN A LIQUID CRYSTAL DISPLAY APPARATUS AND THE LIQUID CRYSTAL DISPLAY APPARATUS

(71) Applicant: BOE TECHNOLOGY GROUP CO., LTD., Beijing (CN)

(72) Inventors: Lilei ZHANG, Beijing (CN); Guangliang SHANG, Beijing (CN); Kailiang ZHANG, Beijing (CN)

(73) Assignee: BOE TECHNOLOGY GROUP CO., LTD., Beijing (CN)

(21) Appl. No.: 13/964,695

(22) Filed: Aug. 12, 2013

(30) Foreign Application Priority Data
Aug. 13, 2012 (CN) 201210287686.8

(51) Int. Cl. G09G 3/36

(52) U.S. Cl. CPC G09G 3/3607
USPC 345/690; 345/89; 345/102

(57) ABSTRACT

The present disclosure relates to a technical field of Liquid Crystal Display (LCD), and particularly discloses a method for inserting frames in a LCD apparatus and the LCD apparatus, for addressing the problem of trails and improving the response time of picture. The method for inserting frames comprises: acquiring gray scale values of chromatic aberrations of individual pixel units on a current N^{th} frame of image according to gray scale values of the individual pixel units and a pre-stored gray to gray (GTG) response time relationship of a liquid crystal; and inserting and displaying a chromatic aberration image frame between the N^{th} frame of image and the (N+1)^{th} frame of image.

### TECHNICAL FIELD

The disclosures relates to a field of a Liquid Crystal Display technique, particularly to a method for inserting frames in a Liquid Crystal Display (LCD) apparatus and the LCD apparatus.

### BACKGROUND

At present, progressive scanning and refresh rate improvement are mainly adopted to enhance the quality of a display device for displaying an image. However, in the existing display mode adopting progressive scanning, a signal of a previous frame of image needs to be maintained before the next frame of image arrives; thus, a visual residue in the previous frame displayed may affect a reception of the next frame of image to be displayed. When a dynamic image of an object moving at a high speed is displayed, a defect of leaving trails might occur.

To address the problem of leaving trails, a solution for increasing the scanning frequency and inserting black frames is proposed in the prior art, that is, the scanning frequency is increased from 60 Hz to 120 Hz, and a black frame is inserted between two frames. Since in this solution, one all-black frame is inserted between every two frames, such a solution can not ensure that a gray scale difference of the liquid crystal between the two frames is a maximum value. For the LCD, a length of a response time of liquid crystal greatly depends on the gray scale difference of the liquid crystal between the two frames. In general, a transform speed and a twist angle of a liquid crystal molecule are determined by the operating voltage applied between a pixel electrode and a common electrode. Larger the gray scale difference of the liquid crystal between the two frames is, larger the operating voltage input from a data line is, and thus the twist speed of the liquid crystal molecule is quicker.

Therefore, the above method for inserting black frames can not ensure that the gray scale difference of the liquid crystal between two frames is the maximum value, and thus can not ensure that the response time of the picture is short enough; as a result, the inserted black frames arc easily perceived by the human eyes, and the definition of the display is decreased.

### SUMMARY

Embodiments of the present disclosure provide a method for inserting frames in a Liquid Crystal Display (LCD) apparatus and the LCD apparatus to address the problem of leaving trails, which have a short response time of liquid crystal and a high display quality.

In an example, an embodiment of the present disclosure provides technical solutions as follows.

On the one hand, a method for inserting frames in a LCD apparatus is provided, comprising:

acquiring gray scale values of chromatic aberrations of individual pixel units on a current N^{th} frame of image according to gray scale values of the individual pixel units and a pre-stored gray to gray (GTG) response time relationship of the liquid crystal; wherein the GTG response time relationship of the liquid crystal comprises response time of liquid crystal to change from preset gray scale values to other respective preset gray scale values for the individual pixel units in the liquid crystal display apparatus; the gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image; and

inserting and displaying a chromatic aberration image frame between the N^{th} frame of image and the (N+1)^{th} frame of image, wherein gray scale values of the individual pixel units on the chromatic aberration image frame are the gray scale values of chromatic aberration of the individual pixel units on the N^{th} frame of image.

In an example, the preset gray scale values can be arbitrary gray scale values, and the response time of the liquid crystal to change from the preset gray scale values to other individual preset gray scale values for a pixel unit in the LCD apparatus is obtained in the following way:

measuring the response time of liquid crystal to change from arbitrary gray scale values to other individual gray scale values for the pixel units in the LCD apparatus; or

selecting a plurality of measuring gray scale values, and measuring the response time of liquid crystal to change from any of the measuring gray scale values to other individual measuring gray scale values for the pixel unit in the LCD apparatus; obtaining, by an interpolation method, the response time of liquid crystal to change from other arbitrary gray scale values other than the individual measuring gray scale values to other individual gray scale values for the pixel unit in the LCD apparatus.

In an example, the response time of liquid crystal to change from preset gray scale values to other individual preset gray scale values for a pixel unit in the LCD apparatus is obtained in the following way:

selecting a plurality of measuring gray scale values, wherein the preset gray scale values are the selected plurality of measuring gray scale values, measuring the response time of liquid crystal to change from an arbitrary measuring gray scale values to other individual measuring gray scale values for a pixel unit in the LCD apparatus.

Further, the step of selecting the plurality of measuring gray scale values comprises:

selecting one measuring gray scale value every predetermined number of the gray scale values; or

selecting a plurality of measuring gray scale values arbitrarily.

In an example, the step for acquiring the gray scale values of chromatic aberration of the individual pixel units on the current N^{th} frame of image according to the gray scale values of the individual pixel units and the pre-stored GTG response time relationship of liquid crystal comprises:

measuring the gray scale values of the individual pixel units on the N^{th} frame of image;

searching, in the GTG response time relationship of liquid crystal, gray scale values which are equal to the gray scale values of the individual pixel units or gray scale values to which differences between the gray scale values and the gray scale values of the individual pixel units are less than or equal to a preset threshold value, respectively, for the individual pixel units;

looking up, in the GTG response time relationship of liquid crystal, the shortest response time of liquid crystal to change from the searched gray scale values of the individual pixel units to other gray scale values for the individual pixel units, and determining gray scale values corresponding to the shortest response time of liquid crystal for the individual pixel units as the gray scale values of chromatic aberration of the individual pixel units.

In an example, the preset threshold value corresponding to the gray scale value is half of a difference between two gray scale values adjacent to the gray scale value in the GTG response time relationship of liquid crystal.

In an example, the GTG response time relationship of liquid crystal is a GTG response time table of liquid crystal. In the GTG response time table of liquid crystal, an element at the p^{th} row, the qₜₕ column represents the response time of liquid crystal to change from the gray scale value p to the gray scale value q for a pixel unit; wherein the p is an integer ranging from 0 to R, the q is an integer ranging from 0 to T, the R and T represent a total number of the rows and a total number of the columns in the GTG response time table of liquid crystal, respectively.

Further, the above method comprises the step of

turning off a backlight source of the LCD apparatus, while the chromatic aberration image frame is displaying.

On the other hand, a LCD apparatus comprising a display panel and a display control unit is provided, wherein the display control unit comprises:

a chromatic aberration frame forming module for acquiring gray scale values of chromatic aberrations of individual pixel units on a N^{th} frame of image according to gray scale values of the individual pixel units and a pre-stored gray to gray (GTG) response time relationship of a liquid crystal; wherein the GTG response time relationship of the liquid crystal comprises response time of liquid crystal to change from preset gray scale values to other respective preset gray scale values for the individual pixel units in the liquid crystal display apparatus; the gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image; and

a chromatic aberration frame inserting circuit for inserting and displaying a chromatic aberration image frame between the N^{th} frame of image and the (N+1)^{th} frame of image, wherein gray scale values of the individual pixel units on the chromatic aberration image frame are the gray scale values of chromatic aberration of the individual pixel units on the N^{th} frame of image.

Further, the chromatic aberration frame forming module comprises:

a storage module for saving the GTG response time relation of liquid crystal; and

a processing module for measuring the gray scale values of the individual pixel units on the N^{th} frame of image, and acquiring the gray scale values of chromatic aberration corresponding to the gray scale values of the individual pixel units according to the GTG response time relationship of liquid crystal.

In an example, the chromatic aberration frame inserting circuit is further used for controlling a backlight system to turn off a backlight source of the LCD apparatus while the chromatic aberration image frame is displaying.

In the method for inserting frames in a LCD apparatus and the LCD apparatus provided in the embodiments of the present disclosure, the GTG response time relationship of liquid crystal is established by use of characteristics of the response time of liquid crystal. A chromatic aberration analysis is performed on the individual pixel units on each frame of image according to the relationship, the chromatic aberration image frame having a maximum gray scale difference value with the previous frame is obtained, and the chromatic aberration image frame is inserted between the two adjacent frames and is displayed, which overcomes the defect of the trails, and thus the response time of the inserted frame is shortened and the definition of the display is improved without increasing any costs for circuit controlling.

### BRIEF DESCRIPTION OF THE DRAWINGS

In order to illustrate the technical solutions of the embodiments of the present disclosure or in the prior art more clear, hereinafter the accompanying drawings which are used for describing the embodiments of the present disclosure or the prior art are briefly introduced. For those skilled in the art, other drawings can be obtained based on the accompanying drawings without paying any creative labor.

FIG. 1 is a flow chart of a method for inserting frames provided in an embodiment of the present disclosure; and

FIG. 2 is a schematic diagram showing a Gray To Gray scale (GTG) response time table of the liquid crystal in an embodiment of the present disclosure.

### DETAILED DESCRIPTION OF THE PREFERRED EMBODIMENTS

To make the object, technical solution and advantageous of the present disclosure more clear, hereinafter, a detailed description will be further made to the technical solutions of the embodiments of the present disclosure in connection with the appended drawings. Obviously, the embodiments as described are only a part of the embodiments of the present disclosure, not all of the embodiments of the present disclosure. All other embodiments obtained by those skilled in the art from the disclosure without paying any inventive labor belong to the protection scope of the disclosure.

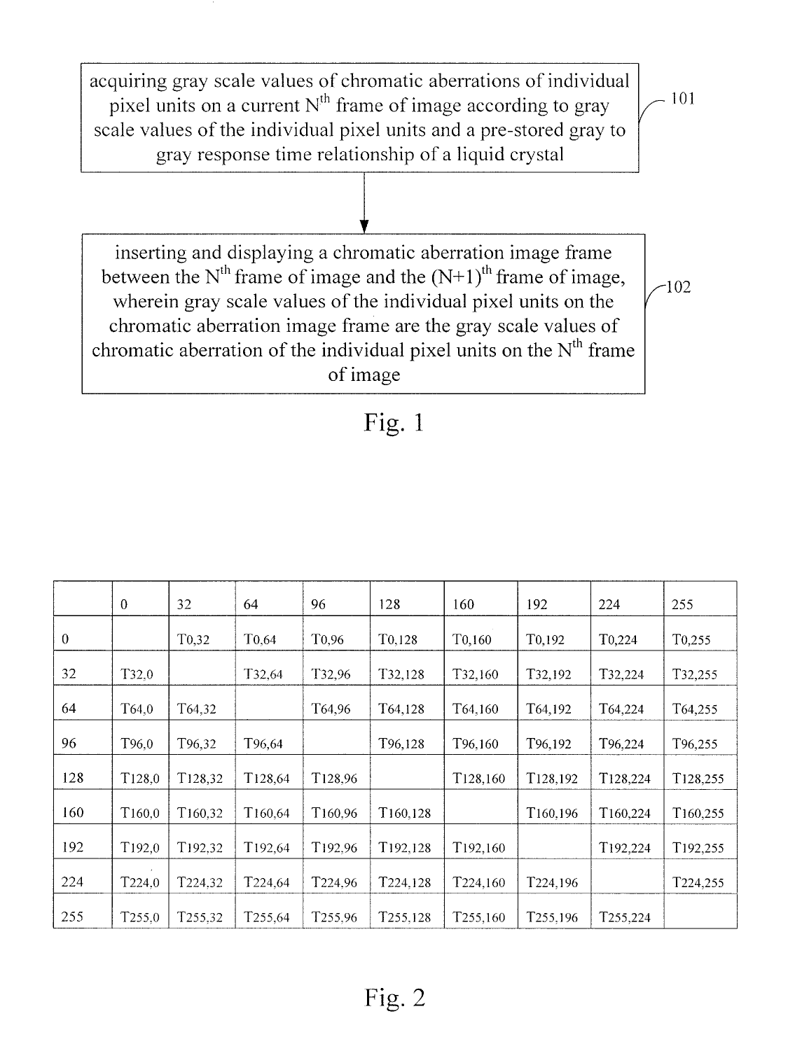

As shown in FIG. 1, the method for inserting frames in a liquid crystal display (LCD) apparatus provided in an embodiment of the present disclosure comprises the steps of:

101, acquiring gray scale values of chromatic aberrations of individual pixel units on a current N^{th} frame of image according to gray scale values of the individual pixel units and a pre-stored gray to gray (GTG) response time relationship of a liquid crystal.

Wherein the GTG response time relationship of the liquid crystal comprises response time of liquid crystal from preset gray scale values to other respective preset gray scale values for the individual pixel units in the liquid crystal display apparatus. The gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image.

102, inserting and displaying a chromatic aberration image frame between the N^{th} frame of image and the (N+1)^{th} frame of image, wherein gray scale values of the individual pixel units on the chromatic aberration image frame are the gray scale values of chromatic aberration of the individual pixel units on the N^{th} frame of image.

In the above method for inserting frames provided in the present embodiment, the GTG response time relationship of liquid crystal is established by using characteristics of the response time of liquid crystal. A chromatic aberration analysis is performed on the individual pixel units on each frame of image according to the GTG response time relationship of liquid crystal, and the gray scale values of chromatic aberration have maximum difference with the gray scale values of the individual pixel units on the frame of image are obtained, and the chromatic aberration image frame comprising the gray scale values of chromatic aberration of the individual pixel units is inserted between the present frame of image and the next frame of image and is displayed so as to alleviate or eliminate a visual residue of the N^{th} frame of image, thus the problem of the leaving trails is addressed. Moreover, since there is a relatively large difference between the gray scale value corresponding to the inserted chromatic aberration image frame and the gray scale value of the N^{th} frame of image, an operating voltage input from a data line is large, so that a response speed of the liquid crystal is rapid. Therefore, the response time of the picture is shortened and the display quality of the display is improved without increasing any costs for circuit controlling.

In an example, in the above step 102, a backlight source is turned off while the chromatic aberration image frame is displaying, it may ensure that the inserted chromatic aberration image frames are not perceived by human eyes, which improves the response time without affecting a viewing effect of the displayed picture.

Hereinafter, the method for inserting frames in the LCD apparatus provided in an embodiment of the present disclosure is described in detail with reference to FIG. 1.

In the above step 101, the GTG response time relationship of liquid crystal varies depending on liquid crystal materials and driving modes of the LCD apparatus. In particularly, the GTG response time relationship of liquid crystal may be embodied in a form of a GTG response time table of liquid crystal. In the GTG response time table of liquid crystal, an element at the p^{th} row, the q^{th} column represents a response time of liquid crystal to change from a gray scale value p to a gray scale value q for a pixel unit; wherein the p is an integer ranging from 0 to R, the q is an integer ranging from 0 to T, and the R and T represent a total number of the rows and a total number of the columns of the GTG response time table of LC, respectively.

In the above step 101, the preset gray scale values may be arbitrary gray scale values of the pixel unit in the LCD apparatus, then the response time of liquid crystal to change from the preset gray scale values to other individual preset gray scale values for the pixel unit in the LCD apparatus is a response time of liquid crystal to change from the arbitrary gray scale values to other individual gray scale values for the pixel unit in the LCD apparatus, and may be obtained in the following ways.

Mode I: measuring, by a testing apparatus for the GTG response time of liquid crystal, the response time T_{pq} of liquid crystal to change from arbitrary gray scale values to other individual gray scale values one by one for the pixel units in the LCD apparatus, and then establishing the GTG response time table of liquid crystal. For instance, in a LCD apparatus with 255 gray scales, the response time T_{pq} of liquid crystal to change from arbitrary gray scale values to other individual gray scale values for a pixel unit is measured one by one, wherein the p and q may determine a row and a column in the table where the T_{pq} is located. Beside the 255 gray scales of the pixel units in the LCD apparatus, a response time of liquid crystal to change from a gray scale value 0 to other individual gray scale values for a pixel unit is further required to be measured. Therefore, the data needed to be measured is up to 256×256. Such a mode has a high precision in measurement, but needs a heavy workload.

Mode II: selecting a plurality of measuring gray scale values, and measuring the response time of liquid crystal to change from arbitrary measuring gray scale values to other individual measuring gray scale values for a pixel unit in the LCD apparatus; obtaining, by an interpolation method, the response time of liquid crystal to change from other arbitrary gray scale values other than the individual measuring gray scale values to other individual gray scale values for the pixel unit in the LCD apparatus, and forming the above GTG response time table of liquid crystal;

Wherein, the selecting of a plurality of measuring gray scale values may comprise a selecting of one measuring gray scale value every predetermined number of gray scale values; also, it may comprise selecting of a plurality of measuring gray scale values arbitrarily.

In an example, in the pixel units of the LCD apparatus with 255 gray scales, one measuring gray scale value is selected every 32 gray scale values, and thus 9 measuring gray scale values are obtained in total, i.e., 0, 32, 64, 96, 128, 160, 192, 224, and 255. Particularly, as shown in FIG. 2, elements in the first row and the first column of the GTG response time table of liquid crystal are the selected 9 measuring gray scale values (0, 32, 64, 96, 128, 160, 192, 224, and 255). An element T_{pq} at the p^{th} row, the q^{th} column represents a response time of liquid crystal to change from a gray scale value p to a gray scale value q for a pixel unit in the LCD. Thereafter, the response time of liquid crystal to change from other arbitrary gray scale values other than the individual measuring gray scale values to other individual gray scale values for the pixel unit in the LCD apparatus is obtained by an interpolation method, and the GTG response time table of liquid crystal comprising the response time of liquid crystal from arbitrary gray scale values to other individual gray scale values is established. Thus, the values in the table are obtained precisely and exactly, reducing huge workload as compared to Mode I.

In an example, in the step 101, the preset gray scale values may be a plurality of measuring gray scale values which are selected from the individual gray scale values of the pixel units in the LCD apparatus, and the response time of liquid crystal to change from the preset gray scale values to other individual preset gray scale values for the pixel units in the LCD apparatus may be obtained by measuring the response time of liquid crystal to change from the arbitrary measuring gray scale values to other individual measuring gray scale value for the pixel units in the LCD apparatus. Wherein the selecting of a plurality of measuring gray scale values may comprise selecting of one measuring gray scale value every predetermined number of gray scale values; also, it may comprise a selecting of a plurality of measuring gray scale values arbitrarily. In particular, for example, in the pixel units of the LCD apparatus with 255 gray scales, the GTG response time table of liquid crystal as shown in FIG. 2 can be obtained by selecting one measuring gray scale value every 32 gray scale values. In a practical operation, the GTG response time table of liquid crystal can be acquired conveniently and quickly in such a way.

In an example, in the above step 101, in a case in which the preset gray scale values are the plurality of the measuring gray scale values which are selected from the individual gray scale values of the pixel units of the LCD apparatus, the step for acquiring the gray scale values of chromatic aberration of the individual pixel units on the current N^{th} frame of image according to the gray scale values of the individual pixel units and the pre-stored GTG response time relation of liquid crystal may comprise:

measuring the gray scale values of the individual pixel units on the N^{th} frame of image; searching, in the GTG response time relationship of liquid crystal, gray scale values which are equal to the gray scale values of the individual pixel units or gray scale values to which differences between the gray scale values and the gray scale values of the individual pixel units are less than or equal to a preset threshold value, respectively, for the individual pixel units; looking up, in the GTG response time relationship of liquid crystal, the shortest response time of liquid crystal to change from the searched gray scale values of the individual pixel units to other gray scale values for the individual pixel units, and determining gray scale values corresponding to the shortest response time of liquid crystal for the individual pixel units as the gray scale values of chromatic aberration of the individual pixel units.

Taking a LCD apparatus comprising pixel units of M rows and L columns as an example, the above steps may be as follows particularly: measuring a gray scale value Gᵢⱼ of the pixel unit at the i^{th} row, the j^{th} column on the N^{th} frame of image; searching, in the GTG response time table of liquid crystal, a gray scale value α which is equal to the Gᵢⱼ or a gray scale value α to which a difference between the α and the Gᵢⱼ is less than or equal to a preset threshold value; looking up, in the GTG response time table of liquid crystal, a shortest response time of liquid crystal to change from the gray scale value α to other gray scale values, and then determining the gray scale value corresponding to the shortest response time of liquid crystal as the gray scale value of chromatic aberration of the pixel unit at the i^{th} row, the j^{th} column; wherein i is an integer ranging from 1 to M, and j is an integer ranging from 1 to L. The gray scale values of chromatic aberration of the individual pixel units on the N^{th} frame of image arc obtained sequentially according to the above method.

In an example, the preset threshold value corresponding to the gray scale value Gᵢⱼ is half of a difference between two gray scale values adjacent to the gray scale value Gᵢⱼ in the GTG response time table of liquid crystal. In particular, taking the GTG response time table of liquid crystal as shown in FIG. 2 as an example, wherein the preset gray scale values are measuring gray scale values obtained by selecting one every predetermined number of gray scale values, if the gray scale value of Gᵢⱼ of the pixel unit at the i^{th} row, the j^{th} column on the N^{th} frame of image is equal to a gray scale value (e.g. the gray scale value 32) in the table as shown in FIG. 2, then the gray scale value α being equal to the Gᵢⱼ may be found directly in the GIG response time table of liquid crystal. If the gray scale value Gᵢⱼ of the pixel unit at the i^{th} row, the j^{th} column on the N^{th} frame of image is equal to none of the gray scale values in the table shown in FIG. 2, a preset threshold value corresponding to the gray scale value Gᵢⱼ needs to be determined. Specifically, an interval between two adjacent gray scale values in the table shown in FIG. 2 is 32, and then a value 16 may be determined as the threshold value. When 0≦|Gᵢⱼ-α|≦16, the shortest response time of liquid crystal to change from the gray scale value α to other gray scale values may be looked up in the GTG response time table of liquid crystal, and a gray scale value corresponding to the shortest response time of liquid crystal may be determined as the gray scale value of chromatic aberration of the pixel unit at the i^{th} row, the j^{th} column.

In the above step 101, for a case in which the preset gray scale values are arbitrary gray scale values, the GTG response time table of liquid crystal is obtained by above mode I or mode II. Since arbitrary gray scale values of the pixel units may be embodied in the table, the gray scale values being equal to the gray scale values of the individual pixel units on the N^{th} frame of image may be found directly in the table; the shortest response time of liquid crystal to change from a gray scale value to other individual gray scale values for the individual pixel units may be in turn looked for in the GTG response time table of liquid crystal, and then the gray scale value corresponding to the shortest response time of liquid crystal of the individual pixel units may be determined as the gray scale values of chromatic aberration of the individual pixel units.

In the above step 102, the chromatic aberration image frame is obtained according to the gray scale values of chromatic aberration of the individual pixel units on the N^{th} frame of image acquired in the step 101, wherein the gray scale values of the individual pixel units on the chromatic aberration image frame are equal to the gray scale values of chromatic aberration of the individual pixel units on the N^{th} frame of image. The chromatic aberration image frame is output to a display screen by a circuit system.

Thus, by inserting a chromatic aberration image frame between the N^{th} frame and the (N+1)^{th} frame, an visual residue of the N^{th} frame of image can be alleviated or eliminated, and thus the problem of the leaving trails can be addressed. Moreover, since there is a relatively large difference between the gray scale values corresponding to the inserted chromatic aberration image frame and the gray scale values of the N^{th} frame of image, an operating voltage input from a data line is large, so that a response speed of the liquid crystal is rapid. Therefore, the response time of a picture is shortened and a definition of the display is improved without increasing any costs for circuit controlling. In an example, in the above step 102, signals of the chromatic aberration image frame may be transmitted to a backlight control system so as to control to turn off a backlight source of the LCD apparatus while the chromatic aberration image frame is being displayed, it may ensure that the inserted chromatic aberration image frame is not perceived by human eyes, which improves the response speed without affecting the viewing effect of the displaying image.

In the above method for inserting frames provided in the present embodiment, the GTG response time relationship of liquid crystal is established by using characteristics of the response time of liquid crystal. A chromatic aberration analysis is performed on the individual pixel units on each frame of image according to the GTG response time relationship of liquid crystal, and the gray scale values of chromatic aberration have maximum differences value with the gray scale values of the individual pixel units on the frame of image are obtained, and the chromatic aberration image frame comprising the gray scale values of chromatic aberration of the individual pixel units is inserted between the present frame of image and the next frame of image and is displayed, thus the problem of the leaving trails is addressed, and the response time of a picture is shortened and the display quality of the display is improved without increasing any costs for circuit controlling. Moreover, the backlight source is turned off while the chromatic aberration image frame is displaying, it may ensure that the inserted chromatic aberration image frame is not perceived by human eyes, which improves the response speed without affecting the viewing effect of the displayed image.

On the basis of the above method, an embodiment of the present disclosure further provides a LCD apparatus comprising a display panel and a display control unit, wherein the display control unit comprises:

a chromatic aberration frame forming module for acquiring gray scale values of chromatic aberrations of individual pixel units on a N^{th} frame of image according to gray scale values of the individual pixel units and a pre-stored gray to gray (GTG) response time relationship of a liquid crystal; wherein the GTG response time relationship of the liquid crystal comprises response time of liquid crystal to change from preset gray scale values to other respective preset gray scale values for the individual pixel units in the liquid crystal display apparatus; the gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image; and

a chromatic aberration frame inserting circuit for inserting and displaying a chromatic aberration image frame between the N^{th} frame of image and the (N+1)th frame of image, wherein gray scale values of the individual pixel units on the chromatic aberration image frame are the gray scale values of chromatic aberration of the individual pixel units on the N^{th} frame of image.

Further, the chromatic aberration frame forming module may comprise:

a storage module for saving the GTG response time relation of liquid crystal; and

a processing module for measuring the gray scale values of the individual pixel units on the N^{th} frame of image, and acquiring the gray scale values of chromatic aberration corresponding to the gray scale values of the individual pixel units according to the GTG response time relationship of liquid crystal.

In an example, the chromatic aberration frame inserting circuit is further used for controlling a backlight system to turn off a backlight source of the LCD apparatus while the chromatic aberration image frame is displaying. Thus, it may ensure that the inserted chromatic aberration image frame is not perceived by the human eyes, which improves the response speed without affecting the viewing effect of the displayed image.

The LCD apparatus provided in the embodiment of the present disclosure may perform the steps of the method in the embodiment of the present disclosure, and achieves respective functions in the method embodiment. In practice, similar procedures can be applied to the LCD application.

The above description is only for illustrating the embodiments of the present disclosure and not for making any limitation to the present disclosure. It should be appreciated for those skilled in the art that many modifications, variations or equivalences can be made in the embodiments of the present disclosure without departing from the spirit and the scope of the disclosure, and that they all fall into the protection scope as claimed in the present disclosure. Therefore, the protection of the present disclosure is defined by the appended claims.

What is claimed is:

1. A method for inserting frames in a liquid crystal display (LCD) apparatus comprising:
acquiring gray scale values of chromatic aberrations of individual pixel units on a current N^{th} frame of image according to gray scale values of the individual pixel units and a pre-stored gray to gray (GTG) response time relationship of a liquid crystal; wherein the GTG response time relationship of the liquid crystal comprises response time of liquid crystal to change from preset gray scale values to other respective preset gray scale values for the individual pixel units in the liquid crystal display apparatus; the gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image; and
inserting and displaying a chromatic aberration image frame between the N^{th} frame of image and the (N+1)^{th} frame of image, wherein gray scale values of the individual pixel units on the chromatic aberration image frame are the gray scale values of chromatic aberration of the individual pixel units on the N^{th} frame of image.

2. The method of claim 1, wherein the preset gray scale values are arbitrary gray scale values, and the response time of the liquid crystal to change from the preset gray scale values to other individual preset gray scale values for a pixel unit in the LCD apparatus is obtained by:
measuring the response time of liquid crystal to change from the arbitrary gray scale values to other individual gray scale values for the pixel units in the LCD apparatus.

3. The method of claim 1, wherein the preset gray scale values are arbitrary gray scale values, and the response time of the liquid crystal to change from the preset gray scale values to other individual preset gray scale values for a pixel unit in the LCD apparatus is obtained by:
selecting a plurality of measuring gray scale values, and measuring the response time of liquid crystal to change from any of the measuring gray scale values to other individual measuring gray scale values for the pixel unit in the LCD apparatus; obtaining, by an interpolation method, the response time of liquid crystal to change from other arbitrary gray scale values other than the individual measuring gray scale values to other individual gray scale values for the pixel unit in the LCD apparatus.

4. The method of claim 1, wherein the preset gray scale values are arbitrary gray scale values, and the response time of the liquid crystal to change from the preset gray scale values to other individual preset gray scale values for a pixel unit in the LCD apparatus is obtained by:
selecting a plurality of measuring gray scale values, wherein the preset gray scale values are the selected plurality of measuring gray scale values, measuring the response time of liquid crystal to change from arbitrary measuring gray scale values to other individual measuring gray scale values for the pixel unit in the LCD apparatus.

5. The method of claim 3, wherein the selecting the plurality of measuring gray scale values comprises:
selecting one measuring gray scale value every predetermined number of the gray scale values.

6. The method of claim 3, wherein the selecting the plurality of measuring gray scale values comprises:
selecting a plurality of measuring gray scale values arbitrarily.

7. The method of claim 4, wherein the step of selecting the plurality of measuring gray scale values comprises:
selecting one measuring gray scale value every predetermined number of the gray scale values.

8. The method of claim 4, wherein the selecting the plurality of measuring gray scale values comprises:
selecting a plurality of measuring gray scale values arbitrarily.

9. The method of claim 1, wherein the acquiring the gray scale values of chromatic aberration of the individual pixel units on the current N^{th} frame of image according to the gray scale values of the individual pixel units and the pre-stored GTG response time relationship of liquid crystal comprises:
measuring the gray scale values of the individual pixel units on the N^{th} frame of image;
searching, in the GTG response time relationship of liquid crystal, gray scale values which are equal to the gray scale values of the individual pixel units or gray scale values to which differences between the gray scale values and the gray scale values of the individual pixel units are less than or equal to a preset threshold value, respectively, for the individual pixel units;
looking up, in the GTG response time relationship of liquid crystal, the shortest response time of liquid crystal to change from the searched gray scale values of the individual pixel units to other gray scale values for the individual pixel units, and determining gray scale values corresponding to the shortest response time of liquid crystal for the individual pixel units as the gray scale values of chromatic aberration of the individual pixel units.

10. The method of claim 9, wherein the preset threshold value corresponding to the gray scale value is half of a difference between two gray scale values adjacent to the gray scale value in the GTG response time relationship of liquid crystal.

11. The method of claim 1, wherein the GTG response time relationship of liquid crystal is a GTG response time table of liquid crystal. In the GTG response time table of liquid crystal, an element at the p^{th} row, the q^{th} column represents the response time of liquid crystal to change from the gray scale value p to the gray scale value q for a pixel unit; wherein the p is an integer ranging from 0 to R, the q is an integer ranging from 0 to T, the R and T represent a total number of the rows and a total number of the columns in the GTG response time table of liquid crystal, respectively.

12. The method of claim 1, wherein the method further comprises:
turning off a backlight source of the LCD apparatus, while the chromatic aberration image frame is displaying.

13. A liquid crystal display (LCD) apparatus comprising a display panel and a display control unit, wherein the display control unit comprises:
a chromatic aberration frame forming module for acquiring gray scale values of chromatic aberrations of individual pixel units on a N^{th} frame of image according to gray scale values of the individual pixel units and a pre-stored gray to gray (GTG) response time relationship of a liquid crystal; wherein the GTG response time relationship of the liquid crystal comprises response time of liquid crystal to change from preset gray scale values to other respective preset gray scale values for the individual pixel units in the liquid crystal display apparatus; the gray scale value of chromatic aberration of each of the individual pixel units is equal to a gray scale value of a pixel unit having a maximum gray scale difference value as compared with the gray scale value of the present pixel unit among the individual pixel units on the current N^{th} frame of image; and
a chromatic aberration frame inserting circuit for inserting and displaying a chromatic aberration image frame between the N^{th} frame of image and the (N+1)^{th} frame of image, wherein gray scale values of the individual pixel units on the chromatic aberration image frame are the gray scale values of chromatic aberration of the individual pixel units on the N^{th} frame of image.

14. The apparatus of claim 13, wherein the chromatic aberration frame forming module comprises:
a storage module for saving the GTG response time relationship of liquid crystal; and
a processing module for measuring the gray scale values of the individual pixel units on the N^{th} frame of image, and acquiring the gray scale values of chromatic aberration corresponding to the gray scale values of the individual pixel units according to the GTG response time relationship of liquid crystal.

15. The apparatus of claim 13, wherein the chromatic aberration frame inserting circuit is further used for controlling a backlight system to turn off the backlight source of the LCD apparatus while the chromatic aberration image frame is displaying.
